(19) United States
(12) Patent Application Publication
(10) Pub. No.: US 2021/0291324 A1
(43) Pub. Date: Sep. 23, 2021

(54) UNIVERSAL SOCKET RATCHET WRENCH

(71) Applicant: TOOLSLAND INVENT. CO., LTD., Shanghai (CN)

(72) Inventor: Janie YOU, Shanghai (CN)

(21) Appl. No.: 16/336,657

(22) PCT Filed: Nov. 25, 2016
(86) PCT No.: PCT/CN2016/107363

§ 371 Date: Mar. 26, 2019

(30) Foreign Application Priority Data
Sep. 26, 2016 (CN) 201621079631.8

(51) Int. Cl. B25B 13/46; B25B 23/00

(52) U.S. Cl. CPC B25B 13/463; B25B 23/0035

(57) ABSTRACT

Provided is a universal socket ratchet wrench. The wrench comprises a ratchet head (1) having a ratchet mechanism therein, and a handle portion (2) detachably connected to the ratchet head (1) to form a ratchet wrench. The ratchet head (1) is a universal socket ratchet head. The invention combines a universal socket with a ratchet to form a universal socket ratchet wrench compatible with screws/bolts of various sizes, thereby solving a problem in which existing wrenches require frequent change of wrench heads or frequent adjustment of operation angles, and increasing utilization efficiency of a wrench.

### BACKGROUND OF THE INVENTION

### 1. Field of the Invention

The invention relates to a hardware wrench tool, more specifically, to a universal socket ratchet wrench.

### 2. Description of the Related Art

There are different types of wrenches. The most common ones are hex wrenches and socket wrenches. The wrenches are generally composed of a wrench head and a handle. The existing wrenches may be equipped with wrench heads of various sizes to fit screws/bolts of various sizes. When in use, the wrench head will be replaced according to the actual situation, which is more troublesome and inconvenient. Or there may be several socket holes of different sizes on the same wrench head. In this case, operation angles or positions need to be changed to correspond to the screws/bolts of various sizes, which is also relatively troublesome. The present invention thereby provides a wrench that integrates various wrench heads corresponding to the screws/bolts of different sizes to facilitate the operation of users.

### SUMMARY OF THE INVENTION

In order to solve the problem existing in the ordinary wrenches that change of wrench heads or operation angles for screws/bolts of various sizes may lead to an inconvenient operation the present invention provides a universal socket ratchet wrench.

In the aim of achieving the above purpose, the present invention provides a universal socket ratchet wrench, which comprises:

a ratchet head having a ratchet mechanism therein,

a handle portion detachably connected to the ratchet head to form a ratchet wrench, wherein the ratchet head is a universal socket ratchet head.

In the above universal socket ratchet head, the ratchet head is composed of a main body member, a universal socket, a pawl, a spring, a body cover and a rotating cover, wherein the universal socket, the pawl and the spring are all installed in an interior of the main body member, and the body cover is disposed on the top of the main body member, and the rotating cover is rotatablely sheathed on the body cover.

In the above universal socket ratchet head, a lower end of the universal socket runs through and is exposed to a bottom of the main body member; an outer circumferential surface of the universal socket is provided with teeth, and the claw of the pawl is meshed with the teeth, and the back of the pawl is connected with the spring, which abuts against an inside wall of the main body member.

In the above universal socket ratchet head, a collar is provided between the rotating cover and the body cover.

In the above universal socket ratchet head, the pawl has a flange, and the flange runs through the body cover and is inlaid in the rotating cover.

In the above universal socket ratchet head, the universal socket is composed of a socket and an inner core assembly, wherein the socket is sheathed outside of the inner core assembly, and the inner core assembly comprises a plurality of positioning pins and a positioning cover, and the plurality of positioning pins are inserted in the positioning cover.

In the above universal socket ratchet head, a guiding post is disposed in a center of the positioning cover.

The beneficial effects of the present invention is that the present invention combines the universal socket with the ratchet to form a universal socket ratchet wrench, which is adapted to screws/bolts of various sizes, thereby solving a problem in which existing wrenches require frequent change of wrench heads or frequent adjustment of operation angles, and significantly increasing utilization efficiency of a wrench.

### BRIEF DESCRIPTIONS OF THE DRAWINGS

The accompanying drawings, together with the specification, illustrate exemplary embodiments of the present disclosure, and, together with the description, serve to explain the principles of the present invention.

FIG. 1 is an exploded view of a universal socket ratchet head according to the embodiment.

FIG. 2 is a perspective view of a universal socket according to the embodiment.

FIG. 3 is a schematic view of a structure connecting a handle and a ratchet head according to the embodiment.

FIG. 4 is a schematic view of a structure departing the ratchet head from the handle according to the embodiment.

FIG. 5 is a schematic view showing the state of use of the handle as a separate screwdriver according to the embodiment.

FIG. 6 is a schematic view showing the structure of a ratchet wrench formed by the ratchet head and an ordinary handle according to the embodiment.

### DETAILED DESCRIPTION

The present invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” or “has” and/or “having” when used herein, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As used herein, the term “plurality” means a number greater than one.

Hereinafter, certain exemplary embodiments according to the present disclosure will be described with reference to the accompanying drawings.

### EXAMPLES

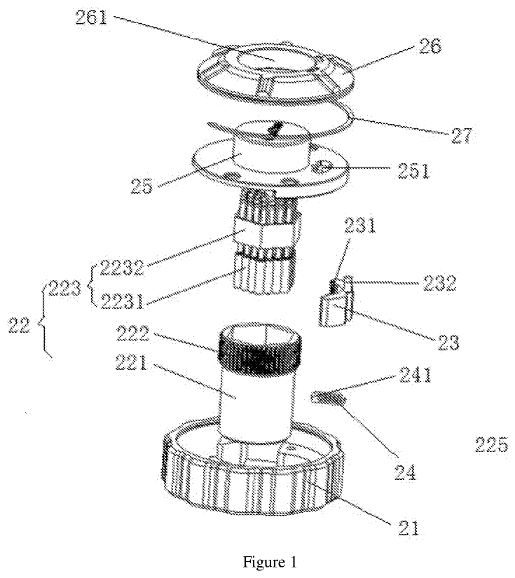

Referring to FIGS. 1 to 6, a preferred embodiment of a universal socket ratchet wrench is shown, which comprises:

a ratchet head 1 having a ratchet mechanism therein,

a handle portion 2 detachably connected to the ratchet head 1, wherein the ratchet head 1 is a universal socket ratchet head.

Continuing to refer to FIGS. 1 to 6, the present invention has the following embodiments on the basis of the above-mentioned example.

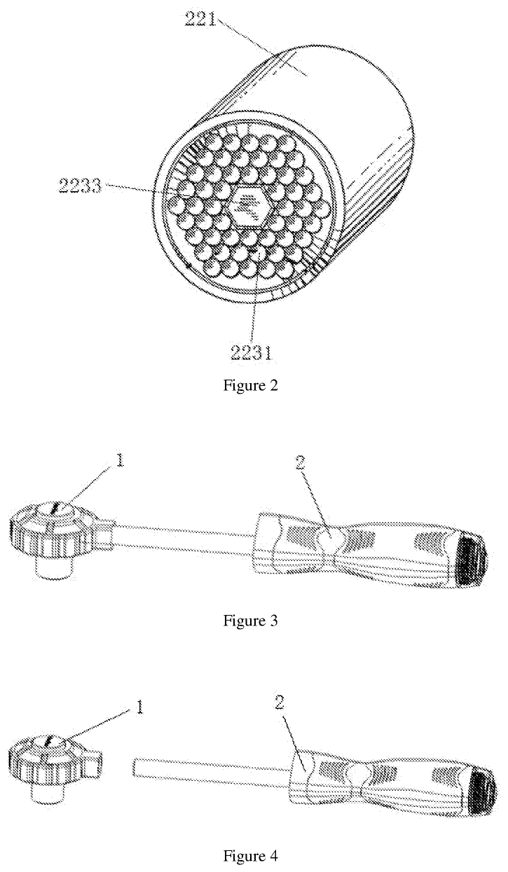

In a further embodiment of the present invention, as shown in FIGS. 1 to 2, the ratchet head 2 is composed of a main body member 21, a universal socket 22, a pawl 23, a spring 24, a body cover 25 and a rotating cover 26, wherein all of the universal socket 22, the pawl 23 and the spring 24 are installed in an interior of the main body member 21, and the body cover 25 is disposed on the top of the main body member 21, and the rotating cover 26 is rotatablely sheathed on the body cover 25. The rotating cover 26 has a through-hole 261 through which the body cover 25 may run.

In a further embodiment of the present invention, a lower end of the universal socket 22 runs through and is exposed to the bottom of the main body member 21; the outer circumferential surface of the universal socket 22 is provided with teeth 222, and the claw 231 of the pawl 232 is meshed with the teeth 222, and the back of the pawl 23 is connected with the spring 24, which abuts on an inside wall of the main body member 21.

In a further embodiment of the present invention, a collar 27 is arranged between the rotating cover 26 and the body cover 25.

In a further embodiment of the present invention, the pawl 23 has a flange 232, and the flange 232 runs through the body cover 25 is inlaid in the rotating cover 26.

In a further embodiment of the present invention, the universal socket 22 is composed of a socket 221 and an inner core assembly 223, wherein the socket 221 is sheathed outside of the inner core assembly 223, and the inner core assembly 223 comprises a plurality of positioning pins 2231 and a positioning cover 2232, and the plurality of positioning pins 2231 are inserted in the positioning cover 2232.

In a further embodiment of the present invention, a guiding post 2233 is disposed in the center of the positioning cover 2232.

The features and functions of the present invention will be further recognized by users according to the following illustration.

Continuing to refer to FIGS. 1 and 2, the ratchet head 1 has a ratchet mechanism and the universal socket 22 therein, and the ratchet mechanism comprises the pawl 23, the spring 24 and the teeth 222 around the circumference of the universal socket 22; all of the universal socket 22, pawl 23 and the spring 24 are installed within the main body member 21, and the claw 231 of the pawl 23 is meshed with the teeth 222, and the back of the pawl 23 is connected with the spring 24. Preferably, a steel ball 241 is arranged between the pawl 23 and the spring 24, the spring 24 abuts against the inside wall of the main body member 21. Therefore, when the universal socket 22 sleeves around the screws/bolts, clockwise rotation or counterclockwise rotation occurs, then the pawl 23 rotates relatively to the teeth 222 and the pawl 23 through the elasticity of the spring 24 firmly grasped on the teeth 222, so that reverse is avoided.

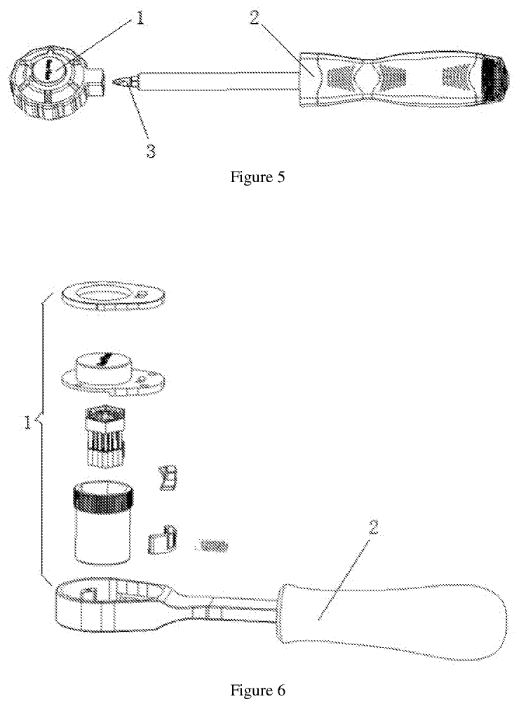

Referring to FIGS. 3 to 5, FIG. 3 is a schematic view showing the structure of the handle connected with the ratchet head according to the embodiment, and FIG. 4 is a schematic view of the structure of the handle departed from the ratchet head according to the embodiment. As shown in the figures, the ratchet head 1 may be detachable from the handle 2, and the handle 2 with the ratchet head 1 removed therefrom can be used separately as a screwdriver, and the end of the shaft of the handle 2 can be used with the screwdriver head 3 (as shown in FIG. 5).

As shown in FIG. 6, FIG. 6 is a schematic view of the structure of the ratchet wrench formed by the ratchet head and an ordinary handle according to the embodiment. The ratchet head 1 may also be used with an ordinary handle 2 to form an ordinary ratchet wrench.

The flange 232 of the pawl 23 runs through the body cover 25 and is inlaid in the rotating cover 26, a through hole 251 is provided on the body cover 25 for the flange 232 to pass through. Preferably, the pawl 23 is of a symmetrical structure and has claws 231 at both ends. Therefore, the rotating cover 26 can choose the claw 231 at any end of the pawl 23 to mesh with the teeth 222, i.e., choosing to rotate the wrench clockwise or anticlockwise for operation.

Continuing to refer to FIG. 2, the inner core assembly 223 in the socket 221 of the universal socket 22 comprises a plurality of positioning pins 2231 and a positioning cover 2232. The positioning cover 2232 has a guiding post 2233 in the center. Preferably, the guiding post 2233 has a regular hexagon shape, and the plurality of positioning pins 2231 are distributed around the guiding post 2233, i.e., a hexagonal column structure is formed step by step, corresponding to internal hexagonal screw of various sizes.

When working, the guiding post 2233 and the plurality of positioning pins 2231 corresponding to a size of screw within the allowable inner angle range of it enter the inner angle of the screw and are inlaid in that inner angle, the plurality of positioning pins 2231 outside the allowable inner angle range of the screw (see series numbered 223 in FIG. 1) lift, so that the screw can be pre-tightened or loosened.

In summary, the present invention combines a universal socket with a ratchet to form a universal socket ratchet wrench compatible with screws/bolts of various sizes, thereby solving a problem in which existing wrenches require frequent change of wrench heads or frequent adjustment of operation angles, significantly increasing utilization efficiency of a wrench.

The above mentioned is only a preferable embodiment of the present invention and is not intended to limit the implementation method and the protection scope of the present invention. Those skilled in the art should be able to notice that the equivalents and obvious modifications made from the description and accompany figures of the present invention should be included within the protection scope of the present invention.

1. A universal socket ratchet wrench, comprising:
a ratchet head having a ratchet mechanism therein,
a handle portion detachably connected to the ratchet head to form a ratchet wrench, wherein the ratchet head is a universal socket ratchet head.

2. The universal socket ratchet wrench according to claim 1, wherein the ratchet head is composed of a main body member, a universal socket, a pawl, a spring, a body cover and a rotating cover, wherein all of the universal socket, the pawl and the spring are installed in an interior of the main body member, and the body cover is disposed on the top of the main body member, and the rotating cover is rotatablely sheathed on the body cover.

3. The universal socket ratchet wrench according to claim 2, wherein a lower end of the universal socket runs through and is exposed to a bottom of the main body member; an outer circumferential surface of the universal socket is provided with teeth, and a claw of the pawl is meshed with the teeth, and the back of the pawl is connected with the spring, which abuts against an inside wall of the main body member.

4. The universal socket ratchet wrench according to claim 2, wherein a collar is arranged between the rotating cover and the body cover.

5. The universal socket ratchet wrench according to claim 2, wherein the pawl has a flange, and the flange runs through the body cover and is inlaid in the rotating cover.

6. The universal socket ratchet wrench according to claim 2, wherein the universal socket is composed of a socket and an inner core assembly, wherein the socket is sheathed outside of the inner core assembly, and the inner core assembly comprises a plurality of positioning pins and a positioning cover, and the plurality of positioning pins are inserted in the positioning cover.

7. The universal socket ratchet wrench according to claim 6, wherein a guiding post is disposed in a center of the positioning cover.
